(19) United States
(12) Patent Application Publication
(10) Pub. No.: US 2013/0325413 A1
(43) Pub. Date: Dec. 5, 2013

(54) RESULTS-BASED TOOL SELECTION, DIAGNOSIS, AND HELP SYSTEM FOR A FEATURE-BASED MODELING ENVIRONMENT

(71) Applicant: Parametric Technology Corporation, Needham, MA (US)

(72) Inventors: Igal KAPSTAN, Sudbury, MA (US); Neil Potter, Litlington Royston (GB); Dubi Landau, Bentleigh East (AU)

(21) Appl. No.: 13/908,638

(22) Filed: Jun. 3, 2013

Related U.S. Application Data
(60) Provisional application No. 61/654,349, filed on Jun. 1, 2012.

(51) Int. Cl. G06F 17/50

(52) U.S. Cl. CPC G06F 17/50
USPC 703/1

(57) ABSTRACT

In modeling environments, a user typically interacts with a feature-based model by manipulating a feature of the model using a tool that is capable of achieving a number of different results with respect to the feature. An interface may be displayed that allows for manipulations to be made based on a result to be achieved, rather than by providing a generalized tool to achieve the result. Accordingly, the number of options that are presented on the interface may be reduced by eliminating extraneous options that are associated with the tool but not directly applicable to the desired result. A dynamic help system may be provided that provides targeted, dynamically-generated information relating to the result to be achieved. Furthermore, warnings may be displayed on the interface in real time during the model design process.

### BACKGROUND

Feature-based modeling environments are modeling environments which may be used to build models using one or more features. A feature may be defined by a geometry, and may be defined with respect to two-dimensional space, three-dimensional space, or both. Features may be combined, stretched, extruded, or otherwise manipulated in order to achieve a shape or series of shapes as desired by a user. Examples of feature-based modeling environments include computer-aided design (CAD) and computer-aided manufacturing (CAM) environments. Feature-based modeling may be used to design, model, test, and/or visualize a product.

In existing feature-based modeling environments, a user may manipulate a feature of the model using one or more tools. A tool is a generalized way of interacting with a feature to manipulate the geometry of the feature in a well-defined manner.

One common example of a tool is the “extrude” tool. The extrude tool may be used to select a surface or a part of a surface of a feature and move the surface in 2D or 3D space. This movement may entail “pulling” the surface away from the rest of the feature, causing new surfaces to be formed. Alternatively, the surface may be “pushed” into the feature to create an indentation in the feature (e.g., creating a “cut” in the feature).

Another example of a tool is the “stretch” tool. The stretch tool may be used to modify the outer edges of a surface of a feature. When one or more edges are moved away from the center of the feature, the stretched edges may cause the feature to grow. In contrast, when one or more edges are moved towards the center of the feature, the stretched edges may cause the feature to shrink.

As can be seen above, a single tool can be used to achieve more than one result. For example, the extrude tool can be used to extend a surface or create an indentation in a surface. The stretch tool can be used to grow a surface or shrink a surface.

A tool may be associated with a number of options that describe how the tool interacts with the feature. Typically, when a tool is selected, each of the options associated with the tool is displayed.

For example, when a new surface is pulled from an existing surface using the extrude tool, several new surfaces may be created, as shown in FIGS. 1A-1B. In FIG. 1A, a surface 110 is present on a feature in a model. The surface 110 includes a portion 120 which has been designated for extrusion by the extrusion tool. As noted above, the extrusion tool may be used to “pull” a surface or a portion of a surface. As shown in FIGS. 1B and 1C, the portion 120 may be pulled away from the surface 110. In doing so, several new surfaces, including surface 130 and surface 140, may be created. As a result of extruding the portion 120, a new cube 150 is created.

When creating the new cube 150, it may be important for the user to specify whether the new cube is hollow or solid. That is, is the interior of the new cube filled with material, or is the interior of the new cube empty so that the cube is defined only by the walls of the cube? Thus, the extrude tool may include options for creating a “solid” cube, or for only creating a “surface” cube.

However, depending on the result to be achieved, some options associated with a particular tool might have reduced importance or no importance to the particular modification contemplated. For example, in addition to “pulling” a surface to create new surfaces as in FIGS. 1A-1C, the extrude tool can also be used to “cut” into a surface to create an indentation (i.e., pushing the portion 120 into the surface 110 of FIG. 1A, rather than pulling the portion 120), as shown in FIG. 1C.

If a user is consistently using the extrude tool to make cuts into a feature, then the user is likely not concerned with the options that allow the user to specify whether the created geometry is solid or hollow. Because an indentation has been created rather than a protrusion, these options are meaningless in the context of a cut as compared to a protrusion. The options to make the cut a solid cut or a hollow cut are therefore extraneous.

It should be noted that the specific tools described above (e.g., “extrude” and “stretch”) may be given different names in different feature-based modeling environments. Throughout the Specification, specific examples may be given with reference to the Creo® family of products from PTC®, of Needham, Mass. One of ordinary skill in the art will recognize that the exemplary embodiments described herein are not limited to a particular family of products, but rather can be applied in any feature-based modeling environment.

### SUMMARY

The display of extraneous information is particularly problematic in a feature-based modeling environment, where the primary focus of the model designer is likely to be on the model being designed rather than the design environment itself. Providing extraneous options reduces the on-screen “real-estate” that is usable by the designer to design the model.

Conventionally, each of the options associated with a tool is displayed upon the activation of the tool because a design environment does not distinguish between a tool and the results that a user might wish to achieve using that tool.

Exemplary embodiments described herein redefine user interactions with a feature-based model in terms of a desired result to be achieved through the interaction, in contrast to the tool to be used to achieve the result. Referring to the examples described above, a user may interact with the model by instructing the design environment to create a solid protrusion, create a hollow protrusion, or create a cut. This is in contrast to selecting the general extrude tool and using the tool to push or pull a surface while specifying an option to make the resulting shape solid, hollow, or a cut.

By focusing on desired results instead of tools, extraneous options associated with the tool (but otherwise irrelevant or having reduced importance for the result to be achieved) can be hidden, resulting in an improved, more efficient modeling environment. Moreover, using a result-driven paradigm rather than a tool-driven paradigm allows for other modifications to streamline the design environment. For example, dynamic, context-sensitive help information can be presented based specifically on the result the user is trying to achieve. Furthermore, potential errors can be identified during the model design process in real-time or near-real-time, when an attribute value or values is/are specified for one or more options associated with the result.

One such error is a violation of a design intent, which can be identified based on the result a user purports to achieve. For example, if a user specifies that the user wishes to create a hollow protrusion, but the user moves a surface in a manner that will instead result in a cut or indentation, then the environment can immediately inform the user that the user's design intent is violated by the proposed modification.

According to one exemplary embodiment, a feature-based modeling environment may be provided, and a computing device may interact with the feature-based modeling environment. The feature-based modeling environment may include a model having at least one feature described by the feature's geometry. The feature-based modeling environment may support at least one tool that defines a manipulation of the geometry of the feature. The manipulation may be applicable to achieve a plurality of different results, where each respective result affects the feature in a different way. A selection of a result to be achieved by the tool may be received, and the geometry of the feature may be manipulated according to the selected result.

In some embodiments, at least two of the plurality of different results may be displayed on an interface of the feature-based modeling environment. The at least two of the plurality of different results may be a subset of the plurality of different results, the subset being selected based on a previous history of result selections. For example, the subset may be selected based on previous user selections of the result and/or options related to the result. In some embodiments, the interface may be displayed in response to receiving the selection of the result to be achieved by the tool, the interface populated with options associated with the tool that are applicable to the selected result.

In some embodiments, another interface may be displayed upon selection of the result to be achieved by the tool. The interface may be populated by options related to the result. The options populating the interface may be user-selected or may be programmatically selected, for example based on previous user interactions. The options that populate the interface may be a subset of the options that are associated with the tool. Furthermore, one or more options that are associated with the tool but are not in the subset may not be presented in the interface. The subset may be a user-defined subset, or may be programmatically defined. In some embodiments, the subset may be dynamically generated at the time the user selects the result to be achieved by the tool.

In order to display the interface associated with the options related to the result, a template may be defined specifying which options are relevant to the result. In one embodiment, a selection of a tool for use with a feature-based modeling environment may be received. The tool may be capable of interacting with one or more surfaces, edges, or vertices of a feature in the feature-based modeling environment to modify the one or more surfaces, edges, or vertices. A plurality of configurable options for the tool may be displayed. The configurable options may be capable of accepting attribute values, where a set of attribute values for the configurable options defines a result of using the tool. One or more of the configurable options may be flagged as relevant to the result or irrelevant to the result.

Subsequently, the result may be displayed as a possible selection. Upon receiving a selection of the result, an interface may be displayed that is associated with the result. The interface may display only the options marked as relevant to the result. Alternatively or in addition, the interface may hide any options marked as irrelevant to the result.

In some embodiments, the interface may be associated with a particular user or group of users. Accordingly, an identity of the user or group of users may be determined and, when the user or group of users subsequently re-enters the modeling environment, the interface that is associated with the user or group of users may be retrieved and displayed.

In another embodiment, the interface may be associated with a feature that was defined using the interface. For example, a feature that is originally manipulated by the user or group of users using the interface may be identified. The interface may be associated with the feature, for example by storing an identification of the interface with the feature (or vice versa). An instruction to interact with the feature associated with the interface may be received from a second user or a second group of users, which may be different from the original user or group of users that manipulated the feature using the interface. As a result of the instruction to interact with the feature, the interface used to originally manipulate the feature may be displayed to the second user or the second group of users. In this way, a consistent interface may be associated with a particular feature across a user base, allowing subsequent users to manipulate the feature in the same way as the feature was originally created.

In some embodiments, if the feature is displayed on a display device, then the interface may be displayed on the display device in a location that is defined based on the location of the feature on the display device. Accordingly, the interface may be provided in close proximity to the feature that is associated with the interface or manipulated by the interface. Thus, a user does not need to search through menus or divert attention away from the feature in question in order to manipulate the feature.

In some embodiments, an evaluation and warning feature is provided that operates in real-time or near-real-time to determine the validity of inputs to options of the model. Accordingly, upon receipt of a selection of a result to be achieved by the tool during a model design process, an interface may be displayed in response to receiving the selection of the result. The interface may be populated with options associated with the tool that are applicable to the selected result. An attribute value for one of the options may be received and the feature may be evaluated using the attribute value. The attribute value may be provided by a user using the interface. The feature may be evaluated during the model design process upon receipt of one or more attribute values for one or more result options. A problem with the attribute value may be identified, and a warning regarding the attribute value may be displayed.

In some embodiments, if the interface including the option is displayed on a display, then the warning may be displayed in a location that is determined based on a location of the option in the interface. In this way, the warning may be displayed in close proximity to the option to assist a user in identifying the source of the warning.

The feature may be evaluated for different error conditions. For example, in one embodiment, the warning may relate to a violation of a geometry rule. In another embodiment, the warning may relate to a violation of a design intent. In yet another embodiment, the warning may indicate a missing or null value.

In some embodiments, a dynamic context-sensitive help page may be displayed after the receipt of a selection of a result to be achieved by the tool during a model design process. In these embodiments, an interface may be displayed in response to receiving the selection of the result. The interface may be populated with options associated with the tool that are applicable to the selected result.

The interface may provide an entry point into a help system. For example, the interface itself may be an entry point. Alternatively, one of the above-described options in the interface may serve as an entry point. The entry point may be an explicit entry point, such as a “?” button provided on the interface. Alternatively, the entry point may be implicit—for example, a user interacting with the interface may press the “F1” key, and the interface may be recognized as an entry point as a result of the user interacting with the interface at the time that help is requested. In these ways and other similar ways, a request to enter the help system from the entry point may be received.

Upon receipt of the request to enter the help system from the entry point, a help page may be dynamically generated with content that is selected based on the entry point. For example, if the entry point is the interface, then the help page may include specific information pertaining only to the interface. If the entry point is an option in the interface, then the help page may be specific to the option. The option may be an option with which the user is currently interacting (such as by entering an attribute value into an option field), and the content may be dynamically generated at the time the request to enter the help system is received based on the option with which the user is currently interacting. The content may further be dynamically generated based on one or more user selections or user-supplied attribute values associated with the option with which the user is currently interacting.

In order to generate the content for the help page, a help system may be provided. The help system may comprise help information. The content selected for display to a user may be a subset of the help information in the help system, and may be dynamically selected based on the entry point.

In this way, targeted help content may be dynamically generated in a way that is most applicable to a user's area of interest.

The present invention may be embodied as instructions stored on a non-transitory computer-readable medium. The instructions may be executed by one or more processors in order to cause the one or more processors to carry out exemplary embodiments of the present invention. The invention may also be embodied as a method executable by a computer. Furthermore, the invention may be embodied as a system, such as a server or computing device, including a memory and a processor for executing instructions to carry out exemplary embodiments.

### BRIEF DESCRIPTION OF THE FIGURES

FIG. 1A depicts a conventional surface 110 of a feature with a portion 120 of the surface 110 marked for extrusion.

FIG. 1B depicts the surface 110 of FIG. 1A after the portion 120 is extruded.

FIG. 1C depicts the surface 110 of FIG. 1A after the portion 120 is extruded in the opposite direction from FIG. 1B.

FIG. 2 depicts an exemplary feature-based model design environment.

FIG. 3 depicts an exemplary interface showing templates 350 for results achieved by an exemplary extrude tool 300.

FIG. 4 depicts exemplary options 402 in an interface 400.

FIG. 5 shows how options 510, 520 can be rearranged in an exemplary interface.

FIG. 6 depicts an option 610 carried over from a first interface to a second interface.

FIG. 7 shows the persistence of an exemplary option value 720 in an interface 710.

FIG. 8 depicts an exemplary interface 800 employing a diagnostic tool in accordance with exemplary embodiments.

FIG. 9 is a flowchart depicting an exemplary method for manipulating features according to exemplary embodiments described herein.

FIG. 10 is a flowchart depicting an exemplary method for associating an interface with a user and/or feature, and recalling the interface when the user creates a new user session or when the feature is accessed by a different user.

FIG. 11 depicts an exemplary dynamically-generated context sensitive help tool 1110.

FIG. 12 is a flowchart depicting an exemplary method for displaying a dynamically-generated context sensitive help tool according to exemplary embodiments described herein.

FIG. 13 depicts an exemplary computing device 800 suitable for use with exemplary embodiments described herein.

FIG. 14 depicts an exemplary network implementation suitable for use with exemplary embodiments described herein.

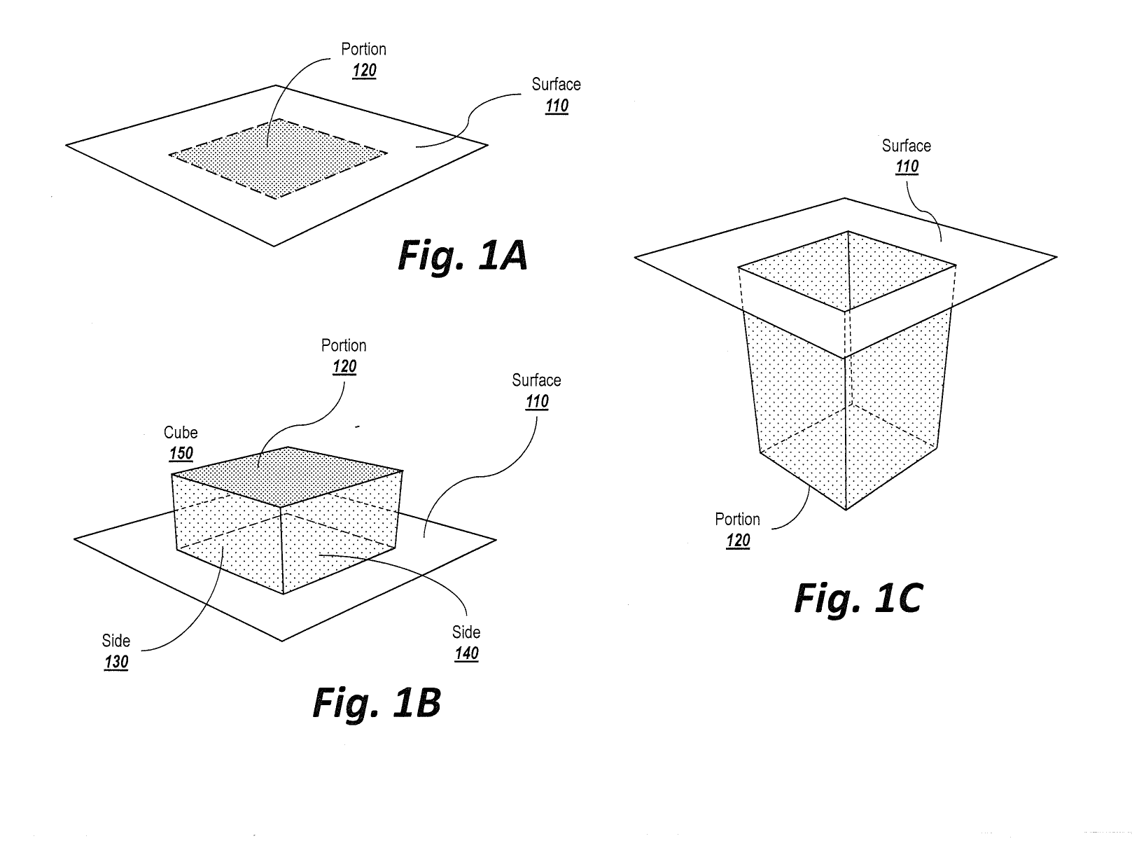

### DETAILED DESCRIPTION

Exemplary embodiments provide a results-biased approach for interacting with features in a feature-based modeling environment. In feature-based modeling environments, a user typically interacts with a feature-based model by manipulating a feature of the model using a tool that is capable of achieving a number of different results with respect to the feature. An interface may be displayed that allows for manipulations to be made based on a result to be achieved, rather than by providing a generalized tool to achieve the result. Accordingly, the number of options that are presented on the interface may be reduced by eliminating extraneous options that are associated with the tool but not directly applicable to the desired result. A dynamic help system may be provided that provides targeted, dynamically-generated information relating to the result to be achieved. Furthermore, feature validity warnings may be displayed on within the interface in real time during the model feature creation process.

These embodiments provide a number of advantages over conventional feature-based modeling environments. For example, because a user manipulates a feature based on the result that the user wishes to obtain, rather than based on a tool that can achieve multiple different results, extraneous tool options can be eliminated or hidden from a normal view. This conserves display real estate for the real subject of interest: the model, as opposed to the modeling environment. Moreover, the amount of time that a user spends looking for tool options in the tool menus of the environment may be reduced. Because the interfaces associated with tools and tool options can be more focused on options of interest to the user's result, the interfaces may be displayed in close proximity to the tool in question, maintaining the user's focus on the model and/or features without the need to move a pointer to other portions of the modeling environment (such as the ribbon or file menus at the top of the screen). Accordingly, the modeling process is made more clean and efficient because the exemplary embodiments described herein may reduce visual scanning, periphery distraction, and mouse travel. Accordingly, the user's visual and mental focus may be maintained on the target and task at hand.

In addition, because the modeling environment is focused on results rather than tools, the modeling environment may be streamlined so that dynamic context-sensitive help can be provided and real-time warnings and errors may be generated. The modeling environment is also made more customizable due to results-oriented templates. For example, a user or administrator may create a that is tailored to a user's type of work, or a company's style standards, which may help to improve user efficiency.

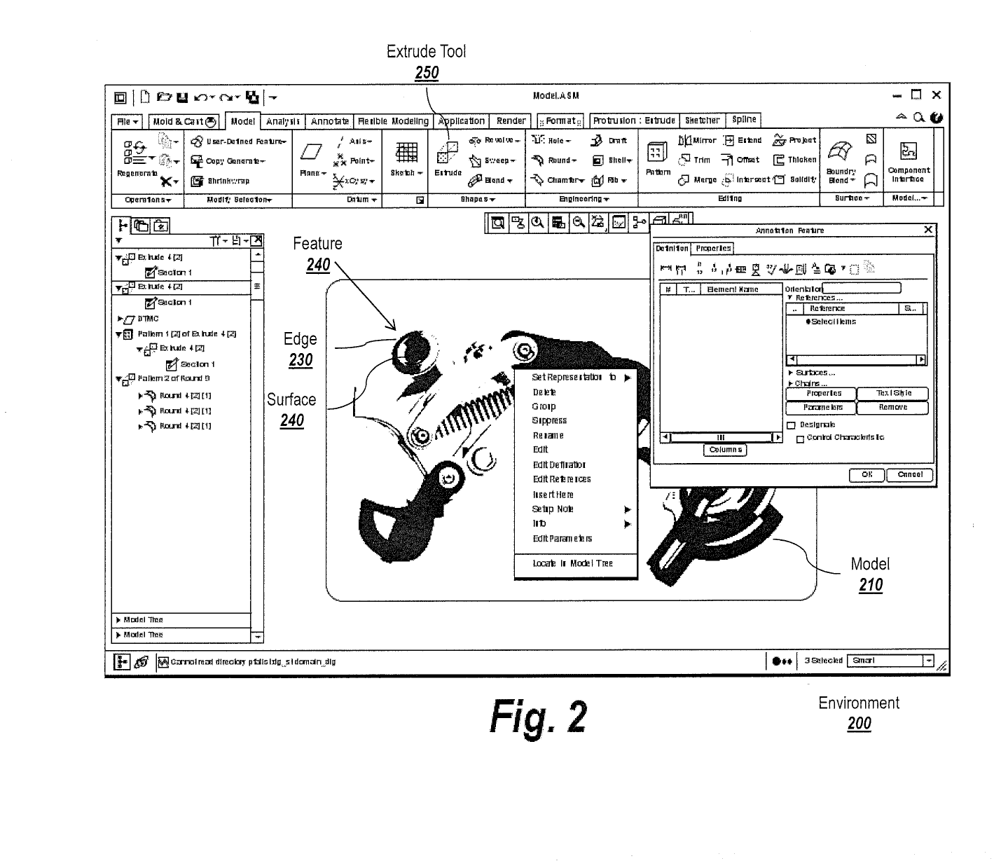

An exemplary feature-based modeling environment 200 is depicted in FIG. 2. In the feature-based modeling environment 200, a user may construct a model 210 by defining the geometry of the model. The geometry that makes up the model is composed of set of “surfaces,” such as the surface 220, which may be bounded by “edges,” such as the edge 230.

As used herein, a “surface” is a face defined by a particular geometry in the model that is bounded by one or more edges. A feature may have one or more surfaces or sets of surfaces. The surfaces may be flat, curved, or angular. For example, a cube has six flat surfaces. A cylinder has flat, circular top and bottom surfaces and a single curved side surface. A cone has a flat, circular bottom surface and a round, tapering, angular side surface that comes to a point at the top of the cone.

As used herein, an “edge” represents the outer boundary of a surface. For example, the front surface of a cube has four edges equal in size and oriented at right angles to each other.

As used herein, a “vertex” is a point at which two or more edges meet. On a cube, vertices are located at each corner, where three edges meet.

A geometry may represent a component, or “feature” of a model, such as the feature 240, which can take a wide variety of shapes or sizes. A connected collection of surfaces, edges, and vertices may define a feature in the model, which can be considered as a standalone atomic component from which a feature-based model may be built.

Feature-based modeling environments generally provide “tools” for manipulating the geometry of a feature. A “tool” is a utility in the environment that manipulates the geometry of a feature in a well-defined way. Examples of tools include the “extrude” tool 250, which moves a surface or a portion of a surface in two dimensional or three dimensional space. Another tool is the “stretch” tool, which moves selected edges and vertices in a specified direction to grow or shrink a surface or an entire feature.

Tools can provide specific “results.” A result describes what happens to a feature when the tool is applied to the feature in a particular way.

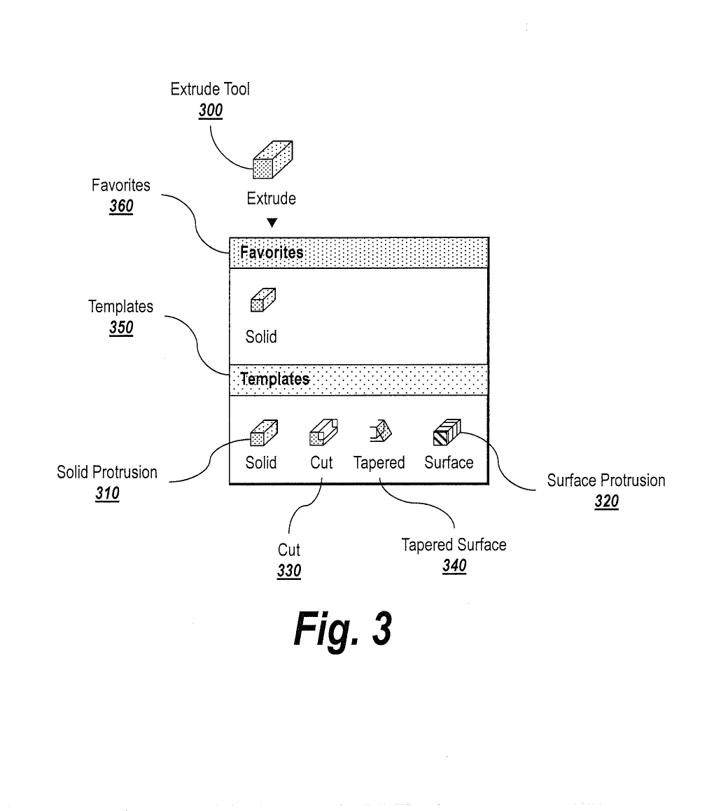

For example, the extrude tool has the general function of pushing or thrusting out a surface or portion of a surface to move the surface or portion of the surface and thereby reshape the feature of which the surface is a part. However, depending on how the surface is manipulated by the extrude tool, different results can be achieved. According to exemplary embodiments of the present invention, users are presented with, and interact with, results-biased tool options in order to manipulate features. FIG. 3. depicts examples of results achieved using the extrude tool 300.

For example, by pushing the surface out of the feature that the surface is a part of, a protrusion can be created. If the protrusion is filled (e.g., the space between the original location of the surface and the new location of the surface is filled with material, such as the material making up the original surface), then a “solid protrusion” 310 is the result of using the extrude tool. If the protrusion is hollow, on the other hand (i.e., the space between the original location of the surface and the new location of the surface is empty, so that only new surfaces defined by the protrusion are created with nothing in between them, then a “surface protrusion” 320 is the result of using the extrude tool. Still further, if the surface is pushed into the feature that the surface is a part of, an indentation or “cut” 330 may be created. If the surface is reduced or increased in size relative to other surfaces, such that the side surfaces are angled, then a “tapered” surface 340 may be created.

Put another way, a tool describes a method for interacting with a feature (e.g., “move a surface of the feature”). A result describes how the feature is changed as a result of using the tool (e.g., “create a solid, filled protrusion on the feature, where the boundaries of the protrusion are defined by the movement of the surface”).

In one embodiment, a tool may be configurable by changing a variety of configurable settings. A particular combination of values for the configurable settings may define a result achieved by the tool. The combination of values that defines a result may be stored as a “result template,” which may be used to build an interface when a user indicates a desire to achieve the result associated with the template by selecting the result in the model environment.

For example, the extrude tool may have a configurable option describing the direction of movement of a surface (e.g., a positive value indicates that the surface is moved away from the feature to create a protrusion, and a negative value indicates that the surface is moved into the feature to create a cut). Another configurable option might provide an option for selecting whether a protrusion created by the extrude tool should be hollow or filled.

It is not necessary for a user to provide values for every possible configuration option for a tool. As noted above, some configuration options may be irrelevant to a particular result. One example would be the option to specify whether a protrusion is solid or hollow for the “cut” result of the extrude tool.

In some instances, a particular configuration option may be relevant to a result, but a user may wish to leave the option blank so that the option can be configured in the future. For example, the extrude tool may be associated with a “depth” configuration option that specifies how far into or out of the feature the surface should be moved. Such an option is likely to be dependent on the particular feature or model that the user is working on at the time, and so may be left to be specified at the time the desired result is selected. In some embodiments, the user can specify a default value to be used for the configuration option, which can later be changed when the result is selected.

As shown in FIG. 3, each of the defined results may be stored as a template 350. A template 350 describes a particular result achieved by a tool out of a plurality of possible results, and each tool may be associated with a plurality of templates 350.

Templates 350 may be prioritized based on a user's previous history. For example, if a user often uses the solid template 310 (e.g., the user uses the solid template at least a predetermined number of times, or at a predetermined rate or ratio as compared to other templates), then the solid template 310 may be stored as a favorite template 360. Alternatively, a user may manually designate a particular template 350 as one of his or her favorite templates 360. Favorite templates 360 may be preferentially displayed in a list of results with which a user may interact.

Templates 350 may also be user definable so that a user may create a template 350 describing a particular result to be achieved by a tool. To that end, the tool may be configurable using tool configurations, and the user may specify in the template 350 which tool configurations are to be used in order to achieve the result. A user may be presented with a wizard or interface in order to set the default tool configuration that corresponds to a particular desired result.

Upon selecting a template 350, a user may be presented with an interface, such as the exemplary interfaces 400, 410 shown in FIG. 4. For example, the interface 410 includes two configuration options 402 and a slider 404. By default, the interface 400 may display only the configuration options that are relevant to a particular result. Other options may be accessed by dragging the slider 404 to increase the size of the interface 400 and reveal additional options 402. Moving the slider 404 in the opposite direction (to decrease the size of the interface 400) may cause fewer options 402 to be displayed. The configuration options that are relevant to a particular result may be determined programmatically (e.g., it may be preprogrammed that the option to specify a solid/hollow setting is irrelevant to the cut result) or may be specified by a user when the template is created (or at a later time by modifying a template).

For example, configuration options may be associated with attributes, such as a “Mandatory/Optional” attribute. Setting such an attribute to “Mandatory” may indicate that the option associated with the attribute must be shown in the interface 410 and cannot be hidden (e.g., by moving the slider 404). In another example, an option may be associated with a “Show/Hide” attribute. Setting the attribute to “Show” may indicate that the option associated with the attribute is displayed by default, but may be hidden by moving the slider 404. Alternatively, setting the attribute to “Hide” may indicate that the option associated with the attribute is not displayed by default, but may be shown by moving the slider 404.

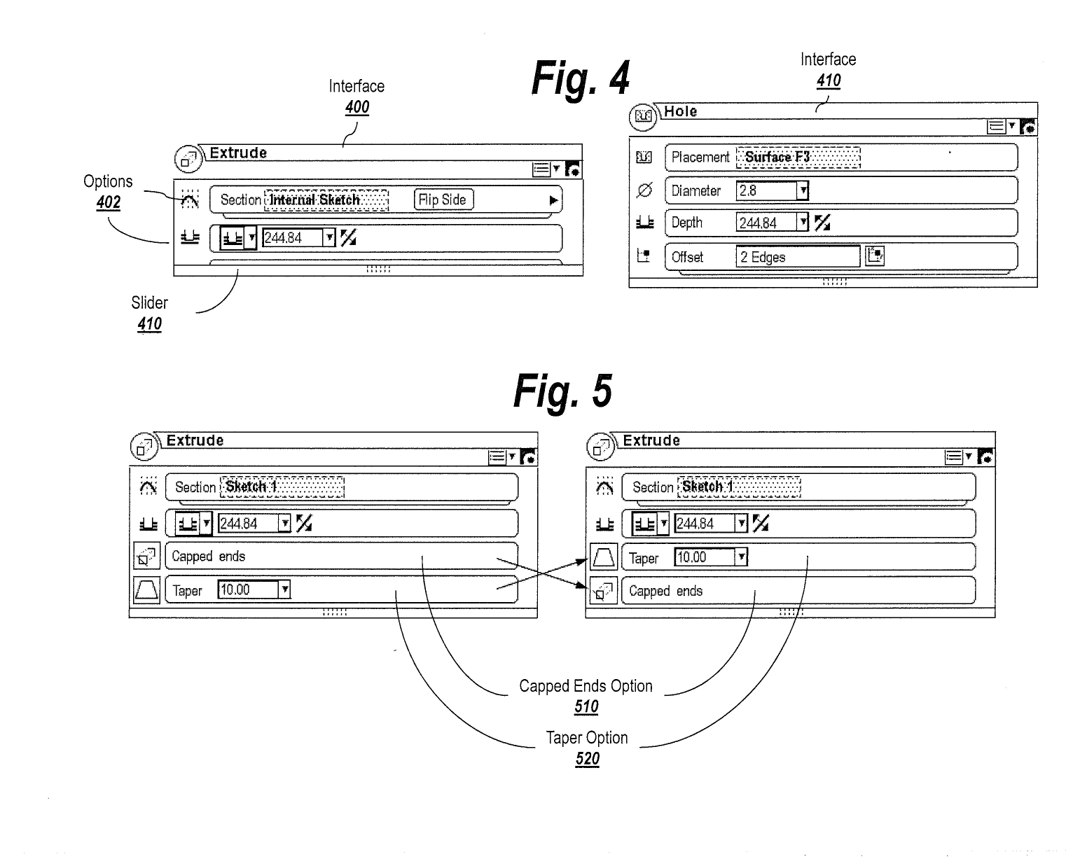

In some embodiments, the options may be ranked relative to one another in order to control the order in which the options appear in the interface 400. For example, the options may each be associated with an absolute ranking that defines their order in the interface 400. Alternatively, as shown in FIG. 5, the relative ordering of options may be specified. For example, in FIG. 5, a user drags the “Capped Ends” option 510 to position the “Capped Ends” option 510 below the “Taper” option 520.

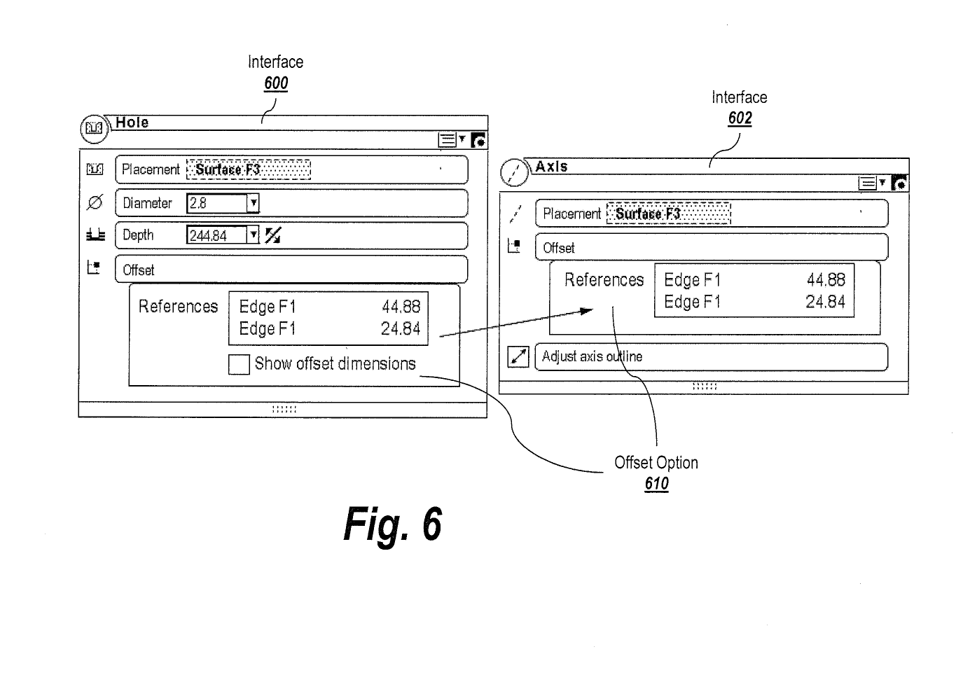

Furthermore, options specified in one template may further be re-used in other, related templates. For example, FIG. 6 shows interfaces 600, 602 for achieving results with two related tools: the “hole” tool, which creates a hole in a feature around a central axis, and an “axis” tool for defining that axis. As shown in FIG. 6, if the “offset” option 610 that defines the center of the hole/axis is defined in one template, the offset option 610 may be carried through to both interfaces 600, 602.

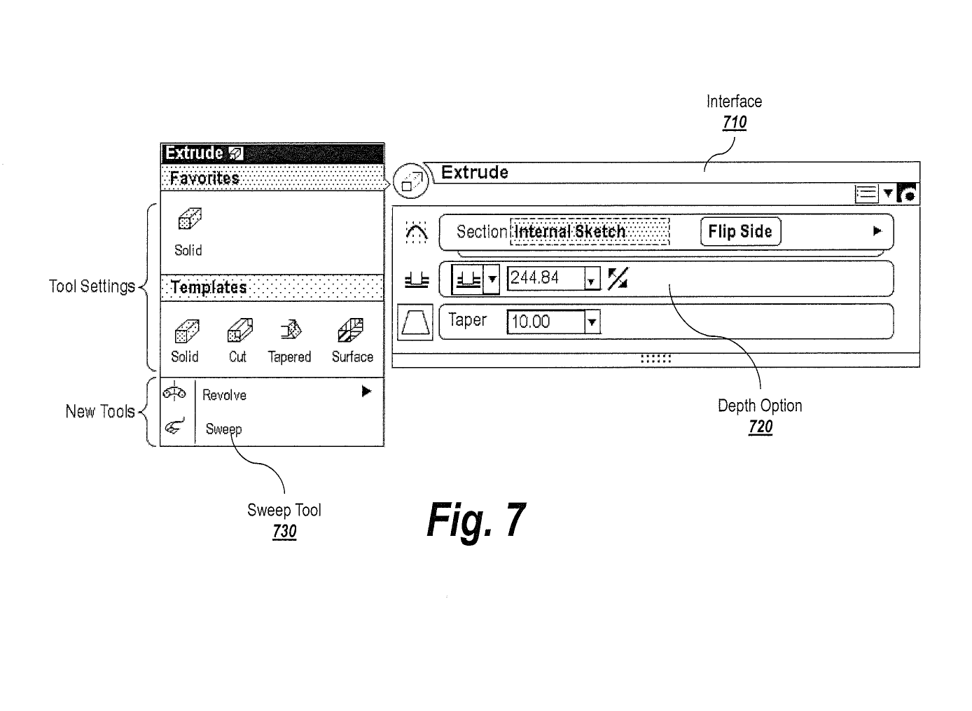

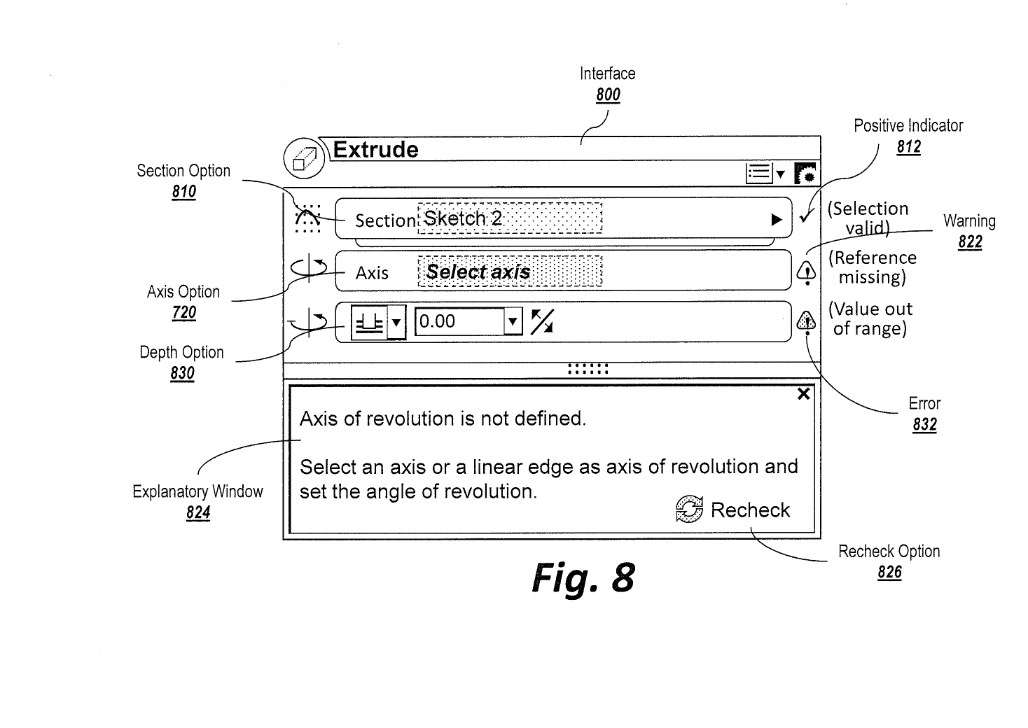

In other embodiments, as shown in FIG. 7, selected options may be made to persist even when the user selects different result or tool to apply. For example, as shown in FIG. 7, a user has selected a result based on the extrude tool. Accordingly, the interface 710 has been displayed and the user has entered a value of “244.84” in the depth option 720. If, at this time, the user selects a new tool (such as the Sweep tool 730) without applying the configured result to the feature, a new interface may be displayed to allow the user to configure the Sweep options. However, the choices made in the interface 710, including the value specified for the depth option 720, may be temporarily stored so that the user can return to the interface 710 at a later time. Accordingly, a user need not reenter each value if the user decides to pursue a different result prior to completing an originally-contemplated manipulation of a feature.

Once the user has specified one or more values for options in the interface, a diagnostic tool may evaluate the feature or the proposed modification using the values in order to determine whether an error will result from the modification. The diagnostic tool may operate in real-time or near-real-time during the model design process and before a proposed manipulation is carried out. For example, FIG. 8 shows such a diagnostic tool in operation.

In the interface 800, a user has specified values for the “Section” option 810 and the “Depth” option 830. No value has been specified for the “Axis” option 820 (or, alternatively, the NULL value has been specified for the “Axis” option 820).

The diagnostic tool may attempt to evaluate the feature with respect to the specified and unspecified options. The diagnostic tool may determine whether any errors result or could result from the modifications that will result from applying the options. The diagnostic tool may perform the evaluation as a value for the option is being entered, or after the value is entered and the user provides some indication that the value is complete (such as by pressing the “enter” or “tab” key). Alternatively, the diagnostic tool may wait until the user specifies a value for each option in the interface 800, or until a value has been specified for the last option in the interface 800. Still further, the diagnostic tool may be manually called up by the user, for example by pressing a designated key (e.g., the “F5” key), at which point the diagnostic tool will evaluate any option values specified in the interface 800.

For example, in attempting to carry out the proposed modification, the diagnostic tool may determine that the “Sketch 2” value specified for the Section option 810 is a valid value. Accordingly, a positive indicator 812 is displayed next to the Section option 810.

However, when attempting to evaluate whether the feature in question can be made to revolve around the specified axis, the diagnostic tool may note that no axis is specified in the Axis option 810. If the Axis is a required field, the diagnostic tool may place a warning signal 822 next to the Axis option 820. Furthermore, an explanatory window 824 may be displayed providing details about the warning signal 822. The explanatory window may provide a recheck option 826 allowing the user to re-evaluate the feature when a new value is entered for the Axis option 820.

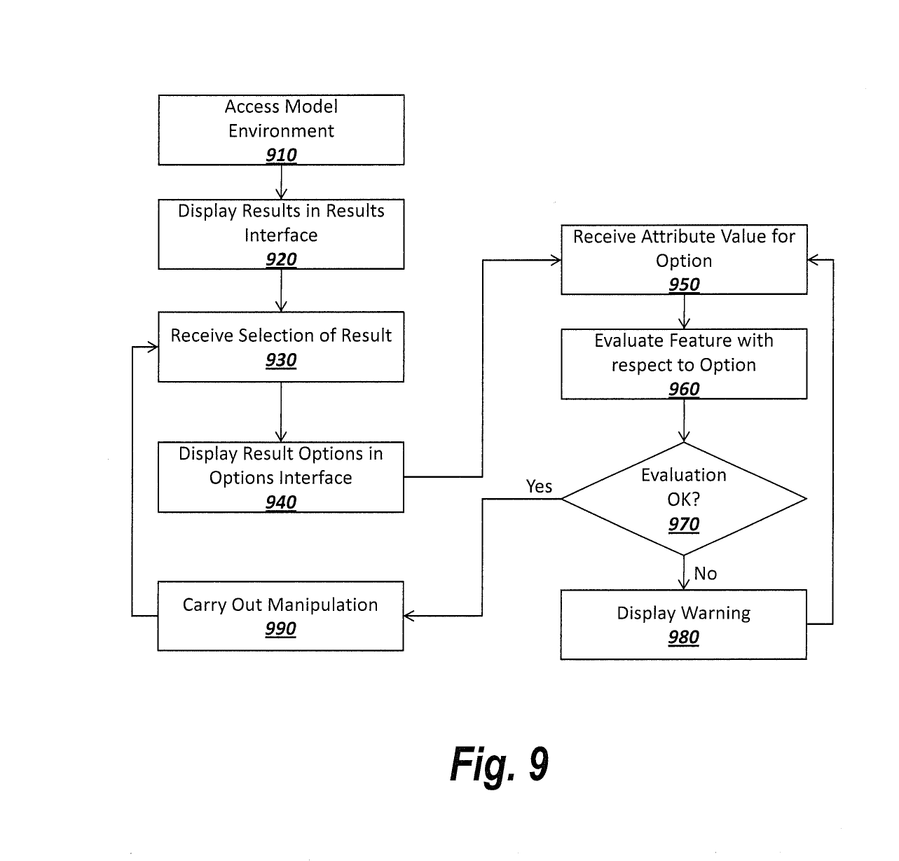

The diagnostic tool may identify that a value is present for the Depth option 820 (i.e., “0.00”). Accordingly, no warning is presented. However, the diagnostic tool may recognize that, when attempting to perform a rotation with a depth of 0.00, the rotation will fail because the value is outside of a valid depth range. Accordingly, an error indicator 832 may be presented in proximity to the Depth option 830. The diagnostic tool is discussed in more detail with respect to FIG. 9.

The above-described embodiments may operate within a feature-based model environment as shown in the flowchart depicted in FIG. 9.

At step 910, a computing device may interact with feature-based modeling environment. The feature-based modeling environment may include a model having at least one feature described by geometry.

At step 920, the feature-based modeling environment may display one or more results that may be used to manipulate a feature of the model. For example, the feature-based modeling environment may support at least one tool that defines a manipulation of the geometry of the feature. The manipulation may be applicable to achieve a plurality of different results, where each respective result affects the feature in a different way.

The results may be, for example, a collection of options, with or without attribute values specified for the options, options that are associated with the tool. In one embodiment, the results may be defined by templates that flag one or more options as relevant to the result, and one or more options as irrelevant to the result. The options may be preprogrammed into the modeling environment, may be customizable templates defined and/or modified by a user or users, or may be programmatically determined based on one or more users' past histories of interacting with tools. For example, if a user uses a tool to achieve a result by specifying tool options more than a predetermined threshold number of times, a template may be programmatically defined storing that result for future use by the user.

In some embodiments, at least two of the plurality of different results may be displayed on an interface of the feature-based modeling environment. The at least results may be a subset of the plurality of different results that are made available by the tool. The subset may be selected based on a previous history of result selections. For example, the subset may be selected based on previous user selections of the result and/or options related to the result.

At step 930 the feature-based modeling environment may receive a selection of a result. For example, a user may select a desired result from a menu or ribbon in the modeling environment.

At step 940, the feature-based modeling environment may display one or more options pertaining to the result in an options interface. In some embodiments, the options interface may be displayed upon selection of the result to be achieved by the tool. The interface may be populated by options related to the result. The options populating the interface may be user-selected or may be programmatically selected, for example based on previous user interactions.

In some embodiments, the options interface may be displayed in response to receiving the selection of the result to be achieved by the tool. The interface may be populated with options associated with the tool that are applicable to the selected result.

The options that populate the interface may be a subset of all of the options that are associated with or available for use with the tool. Furthermore, one or more options that are associated with the tool but are not in the subset may not be presented in the interface. The subset may be a user-defined subset, or may be programmatically defined.

In some embodiments, the subset may be dynamically generated at the time the user selects the result to be achieved by the tool. For example, when a user selects a tool, the model environment may consult a list of “commonly used results” that are frequently achieved with the tool. To that end, the modeling environment may keep track of the options that are selected for use with the tool and identify the frequency with which the options are selected. The model environment may then provide a list of results that correspond to the frequently used configurations of the tool (e.g., configurations that have been used more than a predetermined number of times or at a predetermined rate).

In some embodiments, if the feature is displayed on a display device, then the interface may be displayed on the display device in a location that is defined based on the location of the feature on the display device. For example, the options interface may be displayed within a predetermined distance of the feature, or in a predetermined location that is calculated based on the position of the feature on the display device. Accordingly, the interface may be provided in close proximity to the feature that is associated with the interface or manipulated by the interface. Thus, a user does not need to search through menus or divert attention away from the feature in question in order to manipulate the feature.

At step 950, the feature-based modeling environment may receive an attribute value for one of the options displayed at step 940. For example, the options interface may provide a check box, text box, or other input mechanism for receiving an attribute value for the option. The input mechanism may be pre-filled with a default value that is determined by the template for the result.

At step 960, the feature-based modeling environment may evaluate the feature using the attribute value received at step 950 using a diagnostic tool. The diagnostic tool may operate in real-time or near-real-time to determine the validity of inputs to options of the model. Accordingly, upon receipt of an attribute value for the option, the diagnostic tool may evaluate the feature or a proposed modification of the feature that is achievable using the result having the specified option. The evaluation may occur during the model design process and prior to carrying out the modification using the specified value.

For example, the evaluation may occur as the user enters the attribute value into the input mechanism. Alternatively, after the user has finished entering an attribute value for an option, the user may signal that input is complete, for example by pressing the “enter” or “tab” key. In another embodiment, the diagnostic tool may wait until a predetermined number of values have been specified for different options. Still further, the diagnostic tool may wait until all the options that are visible in the interface have been supplied with values. In another embodiment, the diagnostic tool may wait until the last option listed in the interface is supplied with a value. In each case, instead of supplying a value, a user may simply move beyond the option without supplying a value (e.g., hitting the “tab” key while in the input mechanism for an option to move to the next option without specifying a value).

Moreover, the diagnostic tool need not be automatically called upon receipt of a value (including a NULL value) for an option. For example, a button or other mechanism may be provided allowing a user to manually call the diagnostic tool when the user is ready to evaluate the options supplied. The user may specify that only certain options are to be evaluated, for example using a series of check boxes or by otherwise selecting the options for diagnosis.

At step 970, the diagnostic tool may determine whether the attribute value received at step 960 is present, valid, and/or acceptable (i.e., “OK”). The evaluation may involve comparing the input attribute value to a known range of acceptable values for the option. The evaluation may also check to ensure that a value has been specified for the option, and that the value is of an appropriate type.

The feature may be evaluated for different error conditions. For example, in one embodiment, the warning may relate to a violation of a geometry rule, such as when a user attempts to define a surface that is not bound by edges. Further, the violation of the geometry rule may involve a user specifying a value that is outside of an acceptable range for a manipulation of a geometry defined by the feature. In another embodiment, the warning may indicate a missing or null value.

In yet another embodiment, the warning may relate to a violation of a design intent. The user's design intent may be determined by the modeling environment based on the result that the user indicates that the user is attempting to achieve. For example, if the user indicates that the user is attempting to create a solid protrusion with the extrude tool, but the user specifies a value that causes a surface to move into a feature (thereby creating an indentation or cut), the modeling environment may determine that the user's design intent has been violated. The modeling environment may determine that the design intent is violated even though the value specified (e.g., a negative value for the depth of the surface) would otherwise be a valid value for the extrude tool. Put another way, the user's design intent is defined by the result that the user wishes to achieve, and the modeling environment may compare the attribute values specified for options in the options interface to determine whether the specified values are consistent with the specified result. If the two are not consistent, then the modeling environment determines that the design intent has been violated.

If it is determined at step 970 that the attribute value is not present, valid, and/or acceptable (i.e., “not OK”), then at step 980 the diagnostic tool may display a warning message or failure indication. In some embodiments, if the interface including the option is displayed on a display, then the warning may be displayed in a location that is determined based on a location of the option in the interface. For example, if the option is present at a certain location, the warning may be displayed next to the option, within a predefined distance and/or in a predefined direction away from the option. In this way, the warning may be displayed in close proximity to the option to assist a user in identifying the source of the warning.

If it is determined at step 970 that the attribute value is present, valid, and/or acceptable (i.e., “OK”), then processing may proceed to step 990 where the manipulation defined by the selected result is carried out.

Processing may then return to step 950, where a further attribute value may be supplied and subsequently evaluated. Alternatively, if no further attribute values remain to be supplied, processing may return to step 930 and the user may select a new result to be applied to the model.

In another embodiment, the above-described interfaces (e.g., the results interface and the options interface) may be associated with users, user groups, or features so that the interfaces are displayed consistently. Accordingly, an identity of the user or group of users interacting with the interface may be determined and, when the user or group of users subsequently re-enters the modeling environment, the interface that is associated with the user or group of users may be retrieved and displayed.

Furthermore, the interface may be associated with a feature that was defined using the interface. For example, a feature that is originally manipulated by the user or group of users using the interface may be identified. The interface may be associated with the feature, for example by storing an identification of the interface with the feature (or vice versa). An instruction to interact with the feature associated with the interface may be received from a second user or a second group of users, which may be different from the original user or group of users that manipulated the feature using the interface. As a result of the instruction to interact with the feature, the interface used to originally manipulate the feature may be displayed to the second user or the second group of users.

In this way, a consistent interface may be associated with a particular feature across a user base, allowing subsequent users to manipulate the feature in the same way as the feature was originally created.

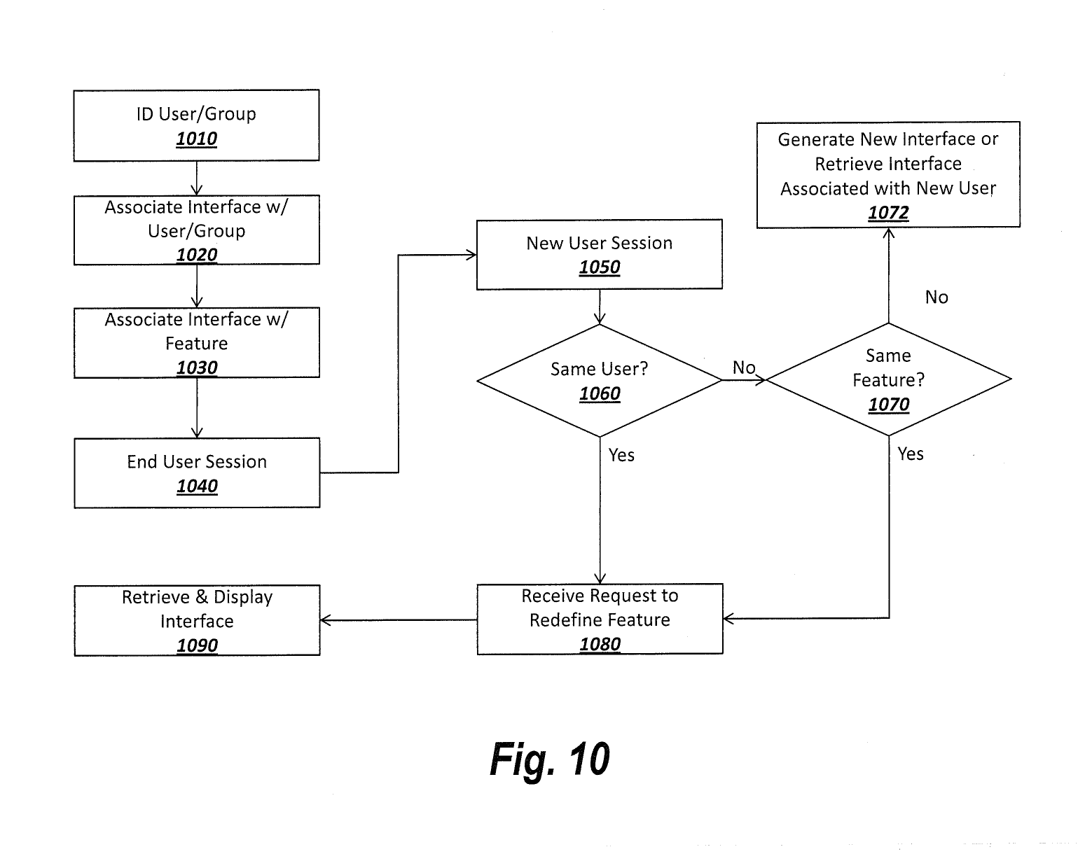

For example, FIG. 10 is a flowchart depicting an exemplary method for associating an interface with a user and/or feature, and recalling the interface when the user creates a new user session or when the feature is accessed by a different user.

At step 1010, the modeling environment may identify a user or group of users accessing the modeling environment. For example, a user or group of users may log into the modeling environment to create a user session. The modeling environment may request proof of identity, such as a password submitted by the user(s).

At step 1020, the modeling environment may associate an interface (e.g., the above-described options interface and/or results interface) being used by the user or group of users to manipulate a feature with the user or group of users. At step 1030, the interface may also be associated with the manipulated feature.

The association may be a logical association. For example, the interface may be identified by an identifier, such as an identification number. The user, group of users, and/or feature may be similarly associated with an identifier. The identifier of the interface may be stored in a data structure, such as a table, array, or linked list, along with the identifier of the user, group of users, and/or feature.

At step 1040, the model environment may detect the end of a user session. For example, the user or group of users may log off of the model environment, close the model environment, or indicate that work has ceased on a model in the model environment (for example, by closing a file associated with or storing the model).

At step 1050, the model environment may detect a new user session. The new user session may be initiated in the same way as the user session described above at step 1010.

At step 1060, the model environment may determine whether the user or group of users associated with the new user session is the same as the user or group of users identified at step 1010. In one embodiment, the model environment may check the above-described data structure to determine if any interfaces have been associated with the currently logged-in user(s) and/or any models that the users are currently manipulating.

If the user or group of users is not determined to be the same at step 1060, then the model environment determines, at step 1070, whether the user or group of users are attempting to manipulate the same feature as was associated with the interface at step 1030. This is because, even if the users are different, it may still be desirable to display a consistent interface when the same model is being manipulated by different users. Thus, even if the users would not be otherwise authorized to use the interfaces stored in the data structure (e.g., because the users did not create the interfaces or because the users have other interfaces associated with them), the users may be temporarily authorized to use the interfaces in order to manipulate the feature associated with the interfaces. In some embodiments, an option may be provided to allow or disallow this functionality so that the users either always see the interface used to create the object, or always see their own user-based interfaces.

If the user or group of users is different and the user or group of users is not attempting to modify the previously-defined feature, then at step 1072 the model environment may display a different interface than the interface that was associated with the user/group of users at step 1020. For example, the model environment may generate a new interface, or may retrieve an interface associated with the specific user or group of users that started the new user session at step 1050.

If, on the other hand, the users identified at step 1060 match the users identified at step 1010, or the user(s) are attempting to manipulate the same feature as was associated with the interface at step 1030, then at step 1080 a request to redefine the feature may be received. In this situation, the interface associated with the users and/or the feature may be retrieved at step 1090 and displayed. The displayed interfaces may be used by the user(s) to manipulate the feature.

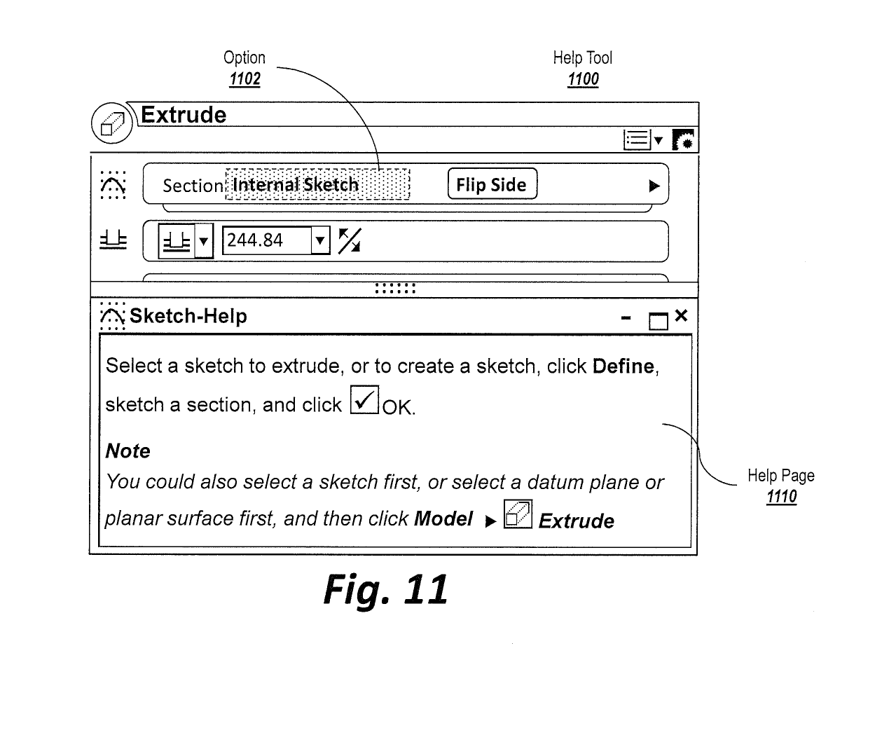

As described above, the interfaces associated with exemplary embodiments of the present invention allow extraneous options to be removed from consideration, to thereby streamline the model design process. Similarly, because the results a user is attempting to achieve are known, a context-sensitive help tool may also be provided. For example, FIG. 11 depicts an exemplary dynamically-generated context sensitive help tool 1110.

The help tool 1100 may be entered from one of the options 1102 in the options interface, and/or through the results interface. The help tool is made context-sensitive due to the use of “entry points.” For example, when the user requests the use of the help tool 1100, the model environment makes note of the location from which the help tool 1100 was requested, and/or what results or options the user was interacting with at the time the help tool 100 was requested.

Based on the entry point for the help tool, the model environment may be capable of determining what result the user was attempting to achieve, and furthermore may be able to identify one or more options that the user has already specified in an attempt to achieve the result. The help tool 1100 may be provided with this information, and may use this information to dynamically generate a help page 1110 that is related to the result the user is attempting to achieve and/or the options that the user is currently specifying (or has already specified, for example if a problem is determined to exist with one of the options by the diagnostic tool).

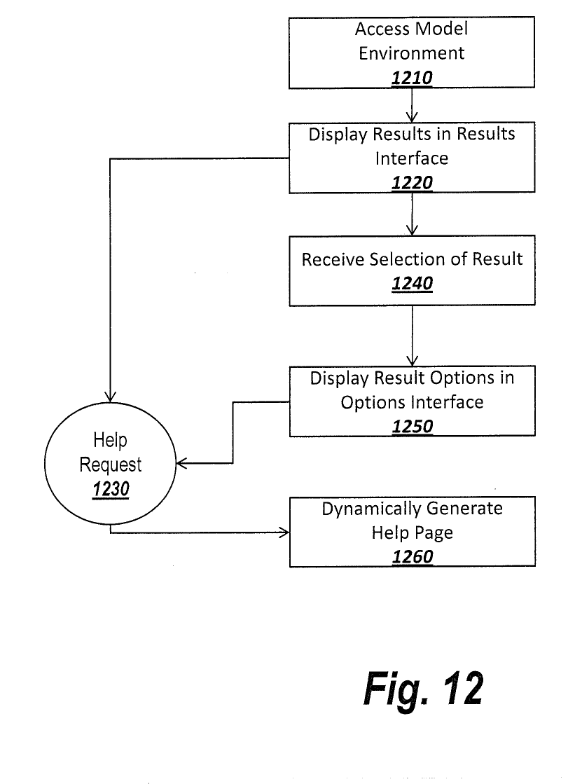

The help tool 1100 of FIG. 11 may be displayed according to a method as depicted in the flowchart of FIG. 12.

At step 1210, a model environment may interact with a model. At step 1220, the modeling environment may display one or more results that can be applied to a feature in the model to modify the feature. Steps 1210 and 1220 generally correspond to steps 910 and 920 of FIG. 9. For brevity's sake, the details of steps 1210 and 1220 are not repeated here.

At step 1230, while displaying potential results, the modeling environment may receive a help request. The model environment may flag the particular result that was being interacted with as an “entry point” into the help system and processing may proceed to step 1260.

The entry point may be an explicit entry point, such as a “?” button provided near one of the results. Alternatively, the entry point may be implicit—for example, a user interacting with the results (e.g., by hovering a mouse pointer over one of the results) may press the “F1” key, and the result being interacted with at the time that help is requested may be recognized as an entry point. In these ways and other similar ways, a request to enter the help system from the entry point may be received.

Alternatively, if a help request is not received while the results are being displayed at step 1220, then the model environment may receive a selection of a desired result at step 1240, and display options pertaining to the selected result in an interface at step 1250. Steps 1240 and 1250 generally correspond to steps 930 and 940, respectively, of FIG. 9 For brevity's sake, the details of steps 1240 and 1250 are not repeated here.

It is understood that an explicit help request need not be generated in order for the help system to be entered. For example, a help page may be generated in response to a user action, such as selecting or activating a particular tool.

A help request may be received while the user is interacting with one of the options displayed at step 1250. In this case, the model environment may flag the particular option that the user was interacting with as the entry point into the help system, and processing may proceed to step 1260.

At step 1260, the model environment identifies the entry point that was flagged at either step 1230 or step 1250. The model environment may then dynamically generate a help page whose content is dependent on the entry point.

Upon receipt of the request to enter the help system from the entry point, a help page may be dynamically generated with content that is selected based on the entry point. For example, if the entry point is the interface, then the help page may include specific information pertaining only to the interface. If the entry point is an option in the interface, then the help page may be specific to the option. The option may be an option with which the user is currently interacting (such as by entering an attribute value into an option field), and the content may be dynamically generated at the time the request to enter the help system is received based on the option with which the user is currently interacting.

In order to generate the content for the help page, help information may be provided. The content selected for display to a user may be a subset of the help information in the help system, and may be dynamically selected based on the entry point. For example, the help system may include information about a tool that can achieve a number of different results. If the entry point is determined to be a result applicable to the tool, then only the subset of the help system that directly addresses the result in question may be displayed.

The help information may include distinct sections that are marked as being relevant to particular entry points. For example, the help sections may be marked by keywords. When a help request is encountered by the help system, the help system may search the help information for the keywords that relate to the entry point and return help content to the user. Keywords relating to the entry point may be based on the name of the entry point (e.g., the name of the tool or options from which the user enters the help system), or may be other words associated with the entry point (e.g., synonyms, preprogrammed related words, etc.). A user may manually flag particular portions of the help information as being relevant to a particular template, and the portions may be associated with the template by storing an identifier of the portions with the template, or by assigning a key word identifying the template in the help information, among other possibilities.

The content may further be dynamically generated based on one or more user selections or user-supplied attribute values associated with the option with which the user is currently interacting. For example, if a user has specified a result to be achieved and has already provided one or more attribute values for the options, the help system may determine that certain portions of the help information are relevant or irrelevant to the user's goal. For example, if the help system determines that an attribute value supplied to the option in a particular result will violate a user's design intent, the help system may provide help content related to the design intent.

The help system may interface with the diagnostic tool to determine whether certain assigned values will cause errors or warnings. For example, if the help system determines that the diagnostic tool would generate an error because a certain value supplied to an option is outside of the option's acceptable range, the help system may provide information about what the acceptable range is.

In this way, targeted help content may be dynamically generated in a way that is most applicable to a user's area of interest or the result that the user is attempting to achieve.

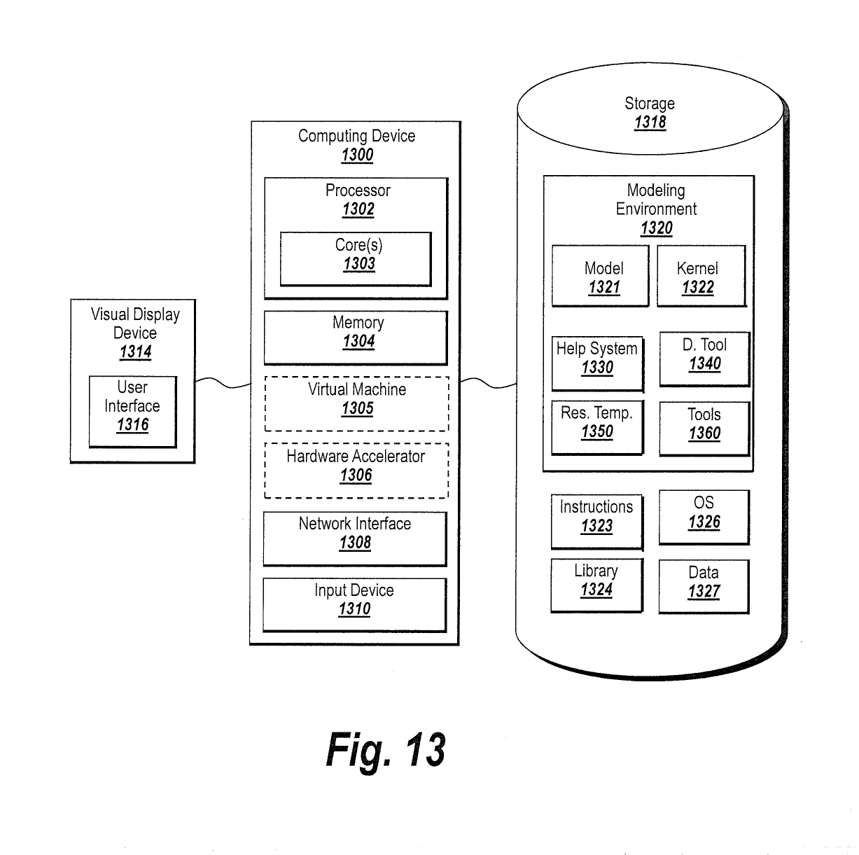

One or more of the above-described acts may be encoded as computer-executable instructions executable by processing logic. The computer-executable instructions may be stored on one or more non-transitory computer readable media. One or more of the above described acts may be performed in a suitably-programmed electronic device. FIG. 13 depicts an example of an electronic device 1300 that may be suitable for use with one or more acts disclosed herein.

The electronic device 1300 may take many forms, including but not limited to a computer, workstation, server, network computer, quantum computer, optical computer, Internet appliance, mobile device, a pager, a tablet computer, a smart sensor, application specific processing device, etc.

The electronic device 1300 is illustrative and may take other forms. For example, an alternative implementation of the electronic device 1300 may have fewer components, more components, or components that are in a configuration that differs from the configuration of FIG. 13. The components of FIG. 13 and/or other figures described herein may be implemented using hardware based logic, software based logic and/or logic that is a combination of hardware and software based logic (e.g., hybrid logic); therefore, components illustrated in FIG. 6 and/or other figures are not limited to a specific type of logic.

The processor 1302 may include hardware based logic or a combination of hardware based logic and software to execute instructions on behalf of the electronic device 1300. The processor 1302 may include logic that may interpret, execute, and/or otherwise process information contained in, for example, the memory 1304. The information may include computer-executable instructions and/or data that may implement one or more embodiments of the invention. The processor 1302 may comprise a variety of homogeneous or heterogeneous hardware. The hardware may include, for example, some combination of one or more processors, microprocessors, field programmable gate arrays (FPGAs), application specific instruction set processors (ASIPs), application specific integrated circuits (ASICs), complex programmable logic devices (CPLDs), graphics processing units (GPUs), or other types of processing logic that may interpret, execute, manipulate, and/or otherwise process the information. The processor may include a single core or multiple cores 1303. Moreover, the processor 1302 may include a system-on-chip (SoC) or system-in-package (SiP). An example of a processor 1302 is the Intel® Core™ series of processors available from Intel Corporation, Santa Clara, Calif.

The electronic device 1300 may include one or more tangible non-transitory computer-readable storage media for storing one or more computer-executable instructions or software that may implement one or more embodiments of the invention. The non-transitory computer-readable storage media may be, for example, the memory 1304 or the storage 1318. The memory 1304 may comprise a RAM that may include RAM devices that may store the information. The RAM devices may be volatile or non-volatile and may include, for example, one or more DRAM devices, flash memory devices, SRAM devices, zero-capacitor RAM (ZRAM) devices, twin transistor RAM (TTRAM) devices, read-only memory (ROM) devices, ferroelectric RAM (FeRAM) devices, magneto-resistive RAM (MRAM) devices, phase change memory RAM (PRAM) devices, or other types of RAM devices.

One or more computing devices 1300 may include a virtual machine (VM) 1305 for executing the instructions loaded in the memory 1304. A virtual machine 1305 may be provided to handle a process running on multiple processors so that the process may appear to be using only one computing resource rather than multiple computing resources. Virtualization may be employed in the electronic device 1300 so that infrastructure and resources in the electronic device may be shared dynamically. Multiple VMs 1305 may be resident on a single computing device 1300.

A hardware accelerator 1306, may be implemented in an ASIC, FPGA, or some other device. The hardware accelerator 1306 may be used to reduce the general processing time of the electronic device 1300.

The electronic device 1300 may include a network interface 1308 to interface to a Local Area Network (LAN), Wide Area Network (WAN) or the Internet through a variety of connections including, but not limited to, standard telephone lines, LAN or WAN links (e.g., T1, T3, 56 kb, X.25), broadband connections (e.g., integrated services digital network (ISDN), Frame Relay, asynchronous transfer mode (ATM), wireless connections (e.g., 802.11), high-speed interconnects (e.g., InfiniBand, gigabit Ethernet, Myrinet) or some combination of any or all of the above. The network interface 708 may include a built-in network adapter, network interface card, personal computer memory card international association (PCMCIA) network card, card bus network adapter, wireless network adapter, universal serial bus (USB) network adapter, modem or any other device suitable for interfacing the electronic device 1300 to any type of network capable of communication and performing the operations described herein.

The electronic device 1300 may include one or more input devices 1310, such as a keyboard, a multi-point touch interface, a pointing device (e.g., a mouse), a gyroscope, an accelerometer, a haptic device, a tactile device, a neural device, a microphone, or a camera that may be used to receive input from, for example, a user. Note that electronic device 1300 may include other suitable I/O peripherals.

The input devices 1310 may allow a user to provide input that is registered on a visual display device 1314. A graphical user interface (GUI) 1316 may be shown on the display device 1314.

A storage device 1318 may also be associated with the computer 1300. The storage device 1318 may be accessible to the processor 1302 via an I/O bus. The information may be executed, interpreted, manipulated, and/or otherwise processed by the processor 1302. The storage device 1318 may include, for example, a storage device, such as a magnetic disk, optical disk (e.g., CD-ROM, DVD player), random-access memory (RAM) disk, tape unit, and/or flash drive. The information may be stored on one or more non-transient tangible computer-readable media contained in the storage device. This media may include, for example, magnetic discs, optical discs, magnetic tape, and/or memory devices (e.g., flash memory devices, static RAM (SRAM) devices, dynamic RAM (DRAM) devices, or other memory devices). The information may include data and/or computer-executable instructions that may implement one or more embodiments of the invention

The storage device 1318 may store any modules, outputs, displays, files, information, user interfaces, etc, provided in exemplary embodiments. The storage device 1318 may store applications for use by the computing device 1300 or another electronic device. The applications may include programs, modules, or software components that allow the computing device 1300 to perform tasks. Examples of applications include word processing software, shells, Internet browsers, productivity suites, and programming software. In one embodiment, the computing device 1300 may include a feature-based modeling environment 1320 for constructing models. The modeling environment 1320 may be, for example, a software component or a computer program. The modeling environment 1320 may be a CAD environment. The modeling environment 1320 may include means for constructing, editing, saving and loading models 1321, simulating the performance of a model 1321, and providing the model 1321 as an input to a rapid prototyping or manufacturing unit. The modeling environment 1320 may further include a geometry kernel 1322, which calculates and represents the geometry of features in the model.

Furthermore, the model environment 1320 may encompass or may be associated with a help system 1330, a diagnostic tool 1340, result templates 1350, and/or one or more tools 1360. Each of these features of the model environment 1320 has been discussed in detail above.

The storage device 1318 may also store an operating system 1326 for operating the computing device 1300. The storage device 1318 may store additional applications for providing additional functionality, as well as data 1327 for use by the computing device 800 or another device. The data 1327 may include files, variables, parameters, images, text, and other forms of data. The storage device 1318 may also store a library 1324, such as a library for storing models 1321 used by the modeling environment 1320. The library 1324 may be used, for example, to store default or custom models or model components.

The storage device 1318 may further store an operating system (OS) 1326 for running the computing device 1300. Examples of OS 826 may include the Microsoft® Windows® operating systems, the Unix and Linux operating systems, the MacOS® for Macintosh computers, an embedded operating system, such as the Symbian OS, a real-time operating system, an open source operating system, a proprietary operating system, operating systems for mobile electronic devices, or other operating system capable of running on the electronic device and performing the operations described herein. The operating system may be running in native mode or emulated mode.

One or more embodiments of the invention may be implemented using computer-executable instructions and/or data that may be embodied on one or more non-transitory tangible computer-readable mediums. The mediums may be, but are not limited to, a hard disk, a compact disc, a digital versatile disc, a flash memory card, a Programmable Read Only Memory (PROM), a Random Access Memory (RAM), a Read Only Memory (ROM), Magnetoresistive Random Access Memory (MRAM), a magnetic tape, or other computer-readable media.

One or more embodiments of the invention may be implemented in a programming language. Some examples of languages that may be used include, but are not limited to, Python, C, C++, C#, SystemC, Java, Javascript, a hardware description language (HDL), unified modeling language (UML), and Programmable Logic Controller (PLC) languages. Further, one or more embodiments of the invention may be implemented in a hardware description language or other language that may allow prescribing computation. One or more embodiments of the invention may be stored on or in one or more mediums as object code. Instructions that may implement one or more embodiments of the invention may be executed by one or more processors. Portions of the invention may be in instructions that execute on one or more hardware components other than a processor.

It is understood that the present invention may be implemented in a distributed or networked environment. For example, models may be provided and manipulated at a central server, while a user interacts with the models through a user terminal.

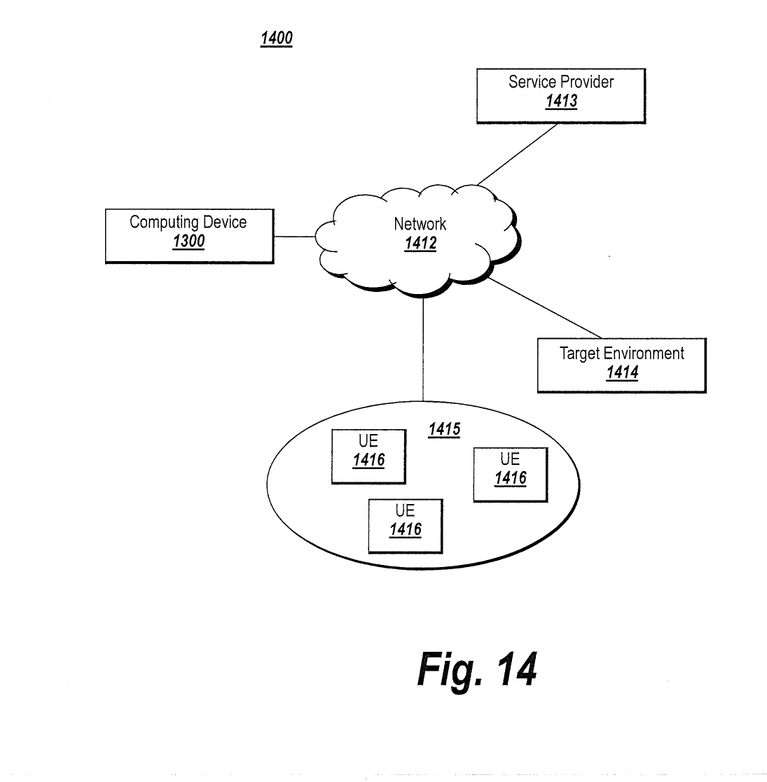

FIG. 14 depicts a network implementation that may implement one or more embodiments of the invention. A system 1400 may include a computing device 1300, a network 1412, a service provider 1413, a target environment 1414, and a cluster 1415. The embodiment of FIG. 14 is exemplary, and other embodiments can include more devices, fewer devices, or devices in arrangements that differ from the arrangement of FIG. 14.

The network 1412 may transport data from a source to a destination. Embodiments of the network 1412 may use network devices, such as routers, switches, firewalls, and/or servers (not shown) and connections (e.g., links) to transport data. Data may refer to any type of machine-readable information having substantially any format that may be adapted for use in one or more networks and/or with one or more devices (e.g., the computing device 1300, the service provider 1413, etc.). Data may include digital information or analog information. Data may further be packetized and/or non-packetized.

The network 1412 may be a hardwired network using wired conductors and/or optical fibers and/or may be a wireless network using free-space optical, radio frequency (RF), and/or acoustic transmission paths. In one implementation, the network 1412 may be a substantially open public network, such as the Internet. In another implementation, the network 1412 may be a more restricted network, such as a corporate virtual network. The network 1412 may include Internet, intranet, Local Area Network (LAN), Wide Area Network (WAN), Metropolitan Area Network (MAN), wireless network (e.g., using IEEE 802.11), or other type of network The network 1412 may use middleware, such as Common Object Request Broker Architecture (CORBA) or Distributed Component Object Model (DCOM). Implementations of networks and/or devices operating on networks described herein are not limited to, for example, any particular data type, protocol, and/or architecture/configuration.

The service provider 1413 may include a device that makes a service available to another device. For example, the service provider 1413 may include an entity (e.g., an individual, a corporation, an educational institution, a government agency, etc.) that provides one or more services to a destination using a server and/or other devices. Services may include instructions that are executed by a destination to perform an operation (e.g., an optimization operation). Alternatively, a service may include instructions that are executed on behalf of a destination to perform an operation on the destination's behalf.

The target environment 1414 may include a device that receives information over the network 1412. For example, the target environment 1414 may be a device that receives user input from the computer 1300.

The cluster 1415 may include a number of units of execution (UEs) 1416 and may perform processing on behalf of the computer 800 and/or another device, such as the service provider 1413. For example, the cluster 1415 may perform parallel processing on an operation received from the computer 1300. The cluster 1415 may include UEs 1416 that reside on a single device or chip or that reside on a number of devices or chips.

The units of execution (UEs) 1416 may include processing devices that perform operations on behalf of a device, such as a requesting device. A UE may be a microprocessor, field programmable gate array (FPGA), and/or another type of processing device. UE 1416 may include code, such as code for an operating environment. For example, a UE may run a portion of an operating environment that pertains to parallel processing activities. The service provider 1413 may operate the cluster 1415 and may provide interactive optimization capabilities to the computer 1300 on a subscription basis (e.g., via a web service).

Units of Execution (UEs) may provide remote/distributed processing capabilities for products such as the modeling environment 1320 of FIG. 13. A hardware unit of execution may include a device (e.g., a hardware resource) that may perform and/or participate in parallel programming activities. For example, a hardware unit of execution may perform and/or participate in parallel programming activities in response to a request and/or a task it has received (e.g., received directly or via a proxy). A hardware unit of execution may perform and/or participate in substantially any type of parallel programming (e.g., task, data, stream processing, etc.) using one or more devices. For example, a hardware unit of execution may include a single processing device that includes multiple cores or a number of processors. A hardware unit of execution may also be a programmable device, such as a field programmable gate array (FPGA), an application specific integrated circuit (ASIC), a digital signal processor (DSP), or other programmable device. Devices used in a hardware unit of execution may be arranged in many different configurations (or topologies), such as a grid, ring, star, or other configuration. A hardware unit of execution may support one or more threads (or processes) when performing processing operations.

A software unit of execution may include a software resource (e.g., a technical computing environment) that may perform and/or participate in one or more parallel programming activities. A software unit of execution may perform and/or participate in one or more parallel programming activities in response to a receipt of a program and/or one or more portions of the program. A software unit of execution may perform and/or participate in different types of parallel programming using one or more hardware units of execution. A software unit of execution may support one or more threads and/or processes when performing processing operations.

The term ‘parallel programming’ may be understood to include multiple types of parallel programming, e.g. task parallel programming, data parallel programming, and stream parallel programming. Parallel programming may include various types of processing that may be distributed across multiple resources (e.g., software units of execution, hardware units of execution, processors, microprocessors, clusters, labs) and may be performed at the same time.

For example, parallel programming may include task parallel programming where a number of tasks may be processed at the same time on a number of software units of execution. In task parallel programming, a task may be processed independently of other tasks executing, for example, at the same time.

Parallel programming may include data parallel programming, where data (e.g., a data set) may be parsed into a number of portions that may be executed in parallel using, for example, software units of execution. In data parallel programming, the software units of execution and/or the data portions may communicate with each other as processing progresses.

Parallel programming may include stream parallel programming (sometimes referred to as pipeline parallel programming). Stream parallel programming may use a number of software units of execution arranged, for example, in series (e.g., a line) where a first software unit of execution may produce a first result that may be fed to a second software unit of execution that may produce a second result given the first result. Stream parallel programming may also include a state where task allocation may be expressed in a directed acyclic graph (DAG) or a cyclic graph.

Other parallel programming techniques may involve some combination of task, data, and/or stream parallel programming techniques alone or with other types of processing techniques to form hybrid-parallel programming techniques.

The foregoing description may provide illustration and description of various embodiments of the invention, but is not intended to be exhaustive or to limit the invention to the precise form disclosed. Modifications and variations may be possible in light of the above teachings or may be acquired from practice of the invention. For example, while a series of acts has been described above, the order of the acts may be modified in other implementations consistent with the principles of the invention. Further, non-dependent acts may be performed in parallel. Further, although features and accessing classes have been described above using particular syntaxes, features and accessing classes may equally be specified using in different ways and using different syntaxes.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware.

Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of a electronic device, unless otherwise stated.

It is intended that the invention not be limited to the particular embodiments disclosed above, but that the invention will include any and all particular embodiments and equivalents falling within the scope of the following appended claims.

1. A non-transitory computer-readable medium storing instructions that, when executed by one or more processors, cause the one or more processors to:
access a modeling environment, the modeling environment providing at least one feature described by a geometry and supporting at least one tool that defines a manipulation of the geometry of the feature, the manipulation being applicable to achieve a plurality of different results, wherein each respective result uses the tool to affect the feature in a different way and corresponds to a different configuration of the tool;
receive a selection of a result to be achieved by the tool; and
manipulate the geometry of the feature according to the selected result.

2. The medium of claim 1, further storing instructions for displaying at least two of the plurality of different results on an interface of the modeling environment.

3. The medium of claim 2, wherein the at least two of the plurality of different results are a subset of the plurality of different results, the subset being selected based on a previous history of result selections.

4. The medium of claim 1, further storing instructions for displaying an interface on a display device in response to receiving the selection of the result to be achieved by the tool, the interface populated with one or more options associated with the tool that are applicable to the selected result.

5. The medium of claim 4, wherein the options that populate the interface are a subset of the options that are associated with the tool, and one or more options that are associated with the tool but are not in the subset are not present in the interface.

6. The medium of claim 5, wherein the interface is associated with a particular user or group of users in a data structure.

7. The medium of claim 6, further storing instructions for:
determining an identity of a user or group of users using the modeling environment;
retrieving an interface that is associated with the identified user or group of users in the data structure; and
displaying the interface on a display device.

8. The medium of claim 7, wherein the retrieved interface is displayed in response to an instruction to redefine a feature previously manipulated using the interface.

9. The medium of claim 6, further storing instructions for:
identifying a feature that is originally manipulated by the user or group of users using the interface;
associating the interface with the feature;
receiving a request to interact with the feature associated with the interface from a second user or a second group of users; and
displaying the interface used to originally manipulate the feature to the second user or the second group of users.

10. The medium of claim 4, wherein at least one of the options is prepopulated with a value based on a previous user interaction with the interface.

11. The medium of claim 4, wherein the feature is displayed on a display device, and the interface is displayed on the display device in a location that is defined based on the location of the feature on the display device.

12. The medium of claim 5, wherein the subset is a user-defined subset.

13. The medium of claim 5, wherein the subset is dynamically determined at the time that the selection of the result to be achieved by the tool is received.

14. A computer-implemented method comprising:
accessing a modeling environment, the modeling environment providing at least one feature described by a geometry and supporting at least one tool that defines a manipulation of the geometry of the feature, the manipulation being applicable to achieve a plurality of different results, wherein each respective result affects the feature in a different way and corresponds to a different configuration of the tool;
receiving a selection of a result to be achieved by the tool; and
manipulating the geometry of the feature according to the selected result.

15. A system comprising:
a memory for storing a model, the model including at least one feature described by a geometry; and
a processor configured to:
provide at least one tool that defines a manipulation of the geometry of the feature, the manipulation being applicable to achieve a plurality of different results, wherein each respective result affects the feature in a different way,
receive a selection of a result to be achieved by the tool, and
manipulate the geometry of the feature according to the selected result.

16. A non-transitory computer-readable medium storing instructions that, when executed by one or more processors, cause the one or more processors to:
receive a selection of a tool for use with a modeling environment, the tool capable of interacting with one or more surfaces, edges, or vertices of a feature in the modeling environment to modify the one or more surfaces, edges, or vertices;
display a plurality of configurable options for the tool, the configurable options being capable of accepting attribute values, wherein a set of attribute values for the configurable options defines a result of using the tool;
flag one or more of the configurable options as relevant to the result or irrelevant to the result;
receive a selection of the result; and
display an interface associated with the result, the interface displaying only the options marked as relevant to the result or hiding the options marked as irrelevant to the result.

17. A non-transitory computer-readable medium storing instructions that, when executed by one or more processors, cause the one or more processors to:
access a modeling environment, the modeling environment providing at least one feature described by a geometry and supporting at least one tool that defines a manipulation of the geometry of the feature, the manipulation being applicable to achieve a plurality of different results, wherein each respective result affects the feature in a different way and corresponds to a different configuration of the tool;
receive a selection of a result to be achieved by the tool during a model design process;
display an interface in response to receiving the selection of the result, the interface populated with options associated with the tool that are applicable to the selected result;
receive an attribute value for one of the options;
evaluate the feature using the attribute value during the model design process and prior to a manipulation being carried out using the received attribute value;
identify a problem with the attribute value; and
display a warning regarding the attribute value.

18. The medium of claim 17, wherein the warning is displayed in a location that is determined based on a location of the option in the interface.

19. The medium of claim 17, wherein the warning relates to a violation of a geometry rule.

20. The medium of claim 17, wherein the warning relates to a violation of a design intent.

21. The medium of claim 17, wherein the warning indicates a missing or null value.

22. The medium of claim 17, wherein the attribute value is provided by a user.

23. A non-transitory computer-readable medium storing instructions that, when executed by one or more processors, cause the one or more processors to:
access a modeling environment, the modeling environment providing at least one feature described by a geometry and supporting at least one tool that defines a manipulation of the geometry of the feature, the manipulation being applicable to achieve a plurality of different results, wherein each respective result affects the feature in a different way and corresponds to a different configuration of the tool;
receive a selection of a result to be achieved by the tool during a model design process;
display an interface on a display device in response to receiving the selection of the result, the interface populated with options associated with the tool that are applicable to the selected result, the interface providing an entry point into a help system;
receive a request to enter the help system from the entry point;
dynamically generate a help page with content that is selected based on the entry point; and
display the dynamically generated help page.

24. The medium of claim 23, wherein the entry point is associated with one of the options in the interface and the help page is specific to the one of the options.

25. The medium of claim 24, wherein the one of the options is an option with which the user is currently interacting, and the content is dynamically generated at the time the request to enter the help system is received based on the option with which the user is currently interacting.

26. The medium of claim 25, wherein the content is dynamically generated based on one or more user selections or user-supplied attribute values associated with the option with which the user is currently interacting.

27. The medium of claim 23, wherein the help system comprises help information, and the content is a subset of the help information that pertains to the entry point.
